(19) United States
(12) Patent Application Publication
(10) Pub. No.: US 2018/0043445 A1
(43) Pub. Date: Feb. 15, 2018

(54) Method and Apparatus for Verifying Length of Work Pieces

(71) Applicants: Philip E. Ross, Fairlawn, OH (US); Douglas A. Ross, JR., Boston, MA (US)

(72) Inventors: Philip E. Ross, Fairlawn, OH (US); Douglas A. Ross, JR., Boston, MA (US)

(21) Appl. No.: 15/674,637

(22) Filed: Aug. 11, 2017

Related U.S. Application Data
(60) Provisional application No. 62/374,225, filed on Aug. 12, 2016.

(51) Int. Cl. B23D 59/00; G01B 21/16

(52) U.S. Cl. CPC B23D 59/001; G01B 21/16; B23D 59/008

(57) ABSTRACT

An apparatus and method for ensuring the accuracy and utility of cut-to-length systems. Multiple channels of measurement are employed, by which a first channel of measurement produces a first measurement of a work piece taken between a cutting mechanism and a limit stopper. A second channel of measurement produces a second measurement, wherein cutting of the work piece by the cutting mechanism cannot be made unless the first measurement agrees with the second measurement.

### TECHNICAL FIELD

The invention herein resides in the art of cut-to-length systems that have a primary mover for indexing material into a cutting area such as a band saw, table saw, circular cut-off saw, and the like. Specifically, the invention is directed to any system that requires multiple channels of measurement to verify the length of a work piece.

### BACKGROUND OF THE INVENTION

Known cut-to-length systems rely on operators to set desired cut lengths using mechanical movements that wear over time causing slippage. Operators are also prone to give incorrect and/or invalid readings. Moreover, mechanical connections loosen as they wear, allowing the mechanical stop to move when it is engaged and cause work pieces to be out of tolerances. Such known systems rely on an operator to set the cut length correctly, but human error is prevalent. Indeed, such systems often require an operator to use an external measuring device, such as a “tape,” which may lead to variations in readings between operators and operations.

Known cut-to-length systems operate in dirty environments where debris and other contaminants may prevent proper movement of the material, resulting in an out-of-tolerance work piece. Moreover, operators typically rely on “spot checking” to determine the quality of a batch of cut pieces, often leading to out-of-tolerance work pieces being overlooked.

Some known cut-to-length systems rely on electromechanical components that have inconsistent and varying reaction times that cause the material/work piece not to index consistently to the same spot, particularly when dealing with heavy materials. Other systems rely on hydraulic mechanisms sensitive to the hydraulic pressure; if the pressure changes in the system, the movement of the material/work piece will also be adversely affected while moving through the system. Still other systems rely on limit switches that may have or may develop over time an over- or under-travel before registering a “stop” signal to the system, causing bad cuts.

The inertia of heavy materials when moving at the velocities of an indexing system will not stop at exactly the same place the system intends a heavy material work piece to stop. Different materials, based on their weight, will stop at different positions, affecting the tolerance of the work piece. Moreover, known cut-to-length systems do not take into account the reaction times of downstream components (limit switches, hydraulics, mechanical stops, heavy materials, relay contacts, etc.) resulting in unreliable and non-deterministic results. However, operators must account for all of these variations in their setup work. The operator is responsible for managing tolerance of cutting the work pieces—as the plus/minus tolerance is not programmable and the operator must consider all of the aforementioned concerns.

While encoders are used in known cut-to-length systems, they are still unreliable because they only measure the primary material mover mechanism (the vise head/assembly, for example). Encoders go out of calibration due to buildup of waste material or the wearing down of the contact wheel.

Finally, material/work pieces slip in the transition and movement of the material/work piece. For example, during the transition from a fixed vise to an index vise, the material may shift slightly; or if both vises let go briefly, the material may roll one way or the other before the vises re-engage the material. While the material is in movement it could hit an edge or burr resulting in slippage, all of which result in erroneous cuts.

It is elementary that material/work pieces that are not within tolerance can subject the end user to enormous cost and waste. A work piece cut too long intended for finishing in a CNC machine has been known to break the CNC machine and/or tooling. An end user wastes valuable time and energy first discovering the out-of-tolerance work piece and then resolving to get a replacement work piece. Similarly, expensive work pieces can be reduced to waste if cut short. The invention herein provides an opportunity for end users and operators to significantly reduce these risks if not eliminate them.

### SUMMARY OF THE INVENTION

The disclosed invention blocks or prevents the saw (aka existing cut-to-length systems) from cutting when a cut would result in an out-of-tolerance work piece being produced. The invention employs a multi-channel measurement system wherein two or more channels must agree before the saw will be allowed to cut the work piece. The invention accounts for the aforementioned “problems” (component reaction times, material slippage, etc.) of existing cut-to-length systems because the invention constantly monitors in real time the material/work piece and verifies the work piece length just before the saw begins the cutting process.

The invention comprises a counter system that allows an operator to enter tolerances and other relevant parameters to ensure work pieces are cut within tolerance. The invention comprises a computer system that monitors all the channels of measurement and ensures the system is indexing the material/work piece correctly; providing the output signals to block or prevent the saw from making a “bad” cut; and notifying the operator when the system is blocked.

Blocking or preventing a saw from making a cut that would result in an out-of-tolerance part/work piece based on the existing system tolerance, measurement and setup as required to be performed by the operator (the first channel of measurement) and the real time movement of the material/work piece in the existing system as required and performed by the invention (secondary channels of measurement) ensures a much higher level of repeatability, precision and accuracy.

The invention enables the operator to dial-in the tolerance the operator requires and the invention does the rest. The invention monitors and tracks every material cut and work piece produced by providing a real-time digital readout of the current position of the material/work piece in the existing cut-to-length systems. This readout facilitates the operator's setup of the system as well as provides additional functions as documented herein, further enabling the operator to perform quick and accurate setup of the saw.

The invention also employs a computer and computer program that affords the operator control over all aspects of setting up the desired cut length and also the ability to block the saw from producing work pieces out of tolerance by using multiple channels of measurement as aforementioned. The invention notifies the operator when the saw cut has been “blocked” and logs information about every cut the system makes. Information includes when (date/time) the cut was made, what the tolerances were, what the kerf setting was, etc.

Specifically, the invention is designed to address the foregoing problems, giving operators more control and confidence that the system is working as intended. In general, the invention reduces waste because “bad” work pieces are not cut. It improves production time because the operator is notified immediately so an issue can be fixed sooner and before a bad work piece is ever produced. It improves production time because the time consumed by bad cuts and the rework needed to produce good cuts is eliminated. It verifies every work piece to be cut is within tolerance (not relying on spot-checking) improving quality of work, reliability and repeatability of the system and work pieces created by system. It independently validates that the saw is working correctly, which allows the operator to run the saw in automatic mode with confidence. It affords the operator more time because less time is needed for manually spot checking work pieces and otherwise baby-sitting the saw. It affords more time for downstream processing of work pieces, as oversized work pieces, which would take longer to finish to the correct tolerance, would be eliminated. It also prevents short or long work pieces from getting to the end user.

### BRIEF DESCRIPTION OF THE DRAWINGS

For an understanding and appreciation of the invention, reference can be made to the following detailed description and accompanying drawings wherein:

FIG. 1 is a perspective view of the system of the invention showing the various physical elements thereof;

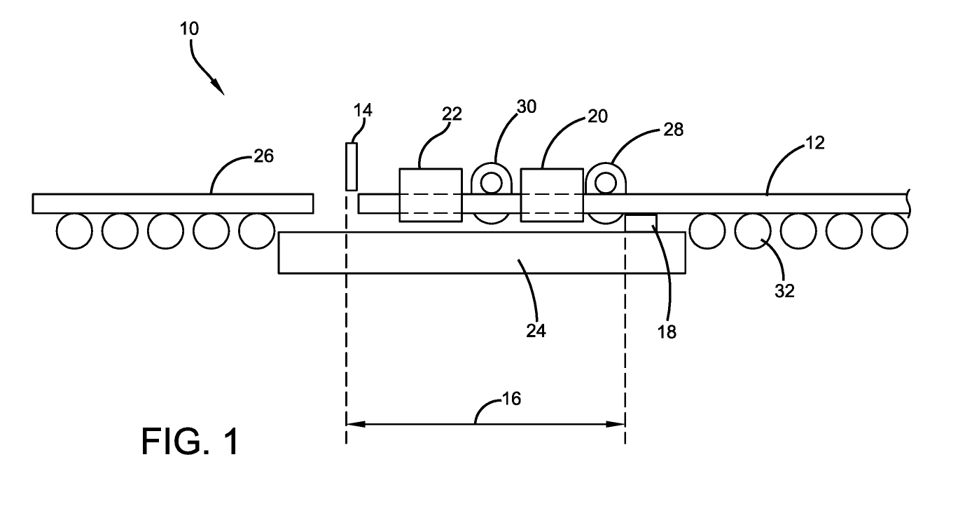

FIG. 2 is a flowchart depiction of a cutting system with a single channel of measurement as known in the prior art;

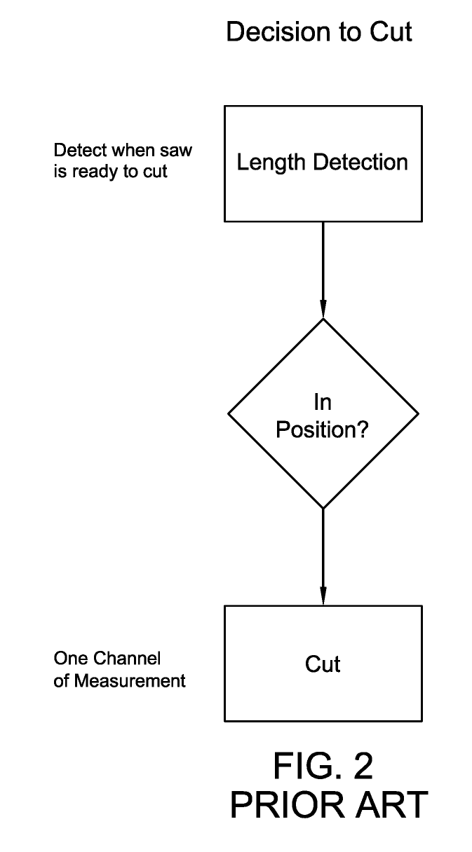

FIG. 3 is a flowchart depiction of a cutting system with two channels of measurement made in accordance with the invention; and

FIG. 4 is a flowchart depiction of a cutting system employing three or more channels of measurement made in accordance with the invention.

### DETAILED DESCRIPTION OF A PREFERRED EMBODIMENT

A cut-to-length system as previously known has only a single channel of measurement. This single channel of measurement is integral to the saw system and essential to the proper functioning of the saw. This single channel of measurement is referred to herein as the primary channel of measurement.

The operator places a work piece 12 into the cut-to-length system 10 and moves (or “indexes”) work piece 12 in order to “zero” the leading edge of work piece 12 to a cutting mechanism, such as saw blade 14. Then the operator must “setup” cut-to-length system 10 to cut the desired cut length 16. To do this, the operator moves (or “indexes”) work piece 12 again to the desired position by measuring from the leading edge of work piece 12 to the part-side of saw blade 14, and adjusts the position of work piece 12 accordingly, until desired cut length 16 is accomplished.

When the operator is satisfied that work piece 12 is in position and the measurement thereof is complete, the operator will “lock in” the measurement. At this point the primary channel of measurement is complete. The operator then allows saw blade 14 to cut work piece 12.

Other cut-to-length systems require the operator to accomplish the same setup, but going the other direction, where the operator now must take into consideration the kerf of saw blade 14. The kerf of a saw blade is defined as the narrow channel left behind by the saw, and (relatedly) the measure of its width, which depends on several factors: the width of the saw blade; the set of the blade's teeth; the amount of wobble created during cutting; and the amount of material pulled out of the sides of the cut. Regardless of the means of entering desired cut length 16, the result is the same. Cut-to length system 10 has a limit stopper/switch 18 that is set based on the measurements made by the operator either assisted by cut-to-length system 10 or not. This constitutes the process of setting the primary channel of measurement.

Other cut-to-length systems require the operator to make a measurement between the saw blade and the primary mover limit stopper. The operator must “enter” the measurement by moving the primary mover or some part thereof to get the cut-to-length system “set up” to the desired cut length. For example, the primary mover may use a mechanical system that may or may not be powered and/or automated to facilitate the operator in the process of setting up the desired cut length.

Operators of other cut-to-length systems are additionally required to perform any additional validation and/or verification that the desired cut length is entered correctly. For example, operators of other cut-to-length systems might verify the desired cut length by cutting a “test” work piece; have another operator “double check” the measurement; and/or some other creative method of validating the desired cut length. Operators must account for the kerf when measuring the work piece and entering the desired cut length, which adds additional opportunity for error.

Additionally, operators of other cut-to-length systems must also account for any tolerances required by the work piece, as other cut-to-length systems do not provide means for entering a plus and/or minus tolerance. Regardless of the particular methods used to “enter” the desired cut length into other cut-to-length systems, the operator is responsible for ensuring that the cut-to-length system will “index” the material correctly to the desired cut length. Furthermore this measurement is only done once before the first cut. If the cut-to-length system is being used in an automatic mode to cut many parts of the same length the operator still only makes the measurement before the first part is cut. The operator and the operator's method of measurement will not measure any of the subsequent parts. The operator relies on the cut-to-length system to “repeat” the measurement each time the saw blade “indexes” the work piece.

Once other cut-to-length systems are set up for their desired cut lengths, an operator starts the saw and enables automatic mode. The saw head receives a “head down” signal from the cut-to-length system and begins to move the saw blade toward the work piece. The saw blade engages the material and cuts thru the work piece until a “part,” cut to the desired cut length, is severed from the work piece. The cut-to-length system detects that the cut is complete, for example, the cut-to-length system detects the saw blade has reached the “bottom” and sends a signal to the saw blade to return to the “top.” For example, limit switches are used to detect the movement of the saw head and generate these two signals. These signals may be referred to as “begin cut” and “end cut,” which indicate that the “saw blade begins moving toward the work piece” and the “saw blade hits bottom,” respectively.

Other cut-to-length systems provide an automatic mode that enables the saw blade to cut multiple parts of the same desired cut length from a work piece. Traditionally, in automatic mode the saw blade “indexes” the work piece using a primary mover. For example, a primary mover will use a fixed vise and an index vise to hold onto and move the work piece under the saw head. These vises are controlled by the cut-to-length system and must maintain a “hold” on the work piece throughout the entire “job;” otherwise the cut-to-length system would be unreliable. The cut-to-length system uses some means of stopping the primary mover, for example, a limit switch or a limit stopper to stop the work piece at the desired cut length. While there are many variations on this important aspect of cut-to-length systems, they all have the same result, which is to stop moving (or “indexing”) the work piece.

With previous cut-to-length systems, the “indexing” of the work piece depends on the initial measurement as “entered” by the operator in order to “repeat” the desired cut length over and over again. The more “parts of the same length and tolerance” the operator needs to cut in a “job,” the more likely a primary mover will index a “part” that is out of tolerance. Furthermore, because the cut-to-length system is not using the operator's method of measure to validate the desired cut length in any given iteration, the cut-to-length system cannot ensure that each part is at the correct desired cut length.

In another example, previous cut-to-length systems use a motor to drive a primary mover and may even compensate for overshooting the position. However, even in this case, the cut-to-length system is not using the operator's method of measure to validate that the work piece is in the correct position to produce a part that is the correct length within tolerance. The cut-to-length system is simply attempting to repeat the positioning of the material based on the initial measurement made by the operator.

Most previous cut-to-length systems are only concerned with the horizontal/lateral movement of material when measuring the length of a part. However, another concern is the vertical displacement of the work piece(s) within the cut-to-length system. Previous cut-to-length systems do not detect vertical movement and do not account for the repeatability of the cut surface edge in relation to the leading edge of the first cut to the trailing edge of the second cut. If the material were to move in a vertical direction to the initial cut, the two planes created by the saw cuts would be different, having an adverse effect on the tolerance of the length of the part, as well as the quality of the trueness of the two planes. This is of particular concern when making miter cuts; keeping the height of the material consistent from cut to cut is required to ensure consistent cuts and within-tolerance miter cuts.

To address these concerns, operators of previous cut-to-length systems must periodically “batch check” samples taken from recently cut parts and then make a determination as to whether all the parts are the correct length and within tolerance. Suffice it to note that batch checking results in much wasted time and material as well as significant risk of out-of-tolerance parts with a single channel of measurement.

In addition to also using a limit switch 18, an index vise 20, a fixed vise 22, and a primary mover 24 as described above, cut-to-length system 10 adds secondary channels of measurement to ensure that each “index” of work piece 12 results in a finished part 26 that is actually desired cut length 16 taking into account tolerances, failures of primary mover 24, obstructions and/or slippage of work piece 12, vertical displacement and other concerns that affect the length and quality of the resulting finished part 26.

Notably, a second channel of measurement addresses potential human error. For example, the operator may measure and/or enter an incorrect value in the process of setting the primary channel of measurement. The data entry in the second channel will help validate that the value entered in the primary channel is correct. Therefore, the data entry in both channels must affirm desired cut length 16 to enable saw blade 14 to cut.

The second channel of measurement has two important components: 1) a sensor 28 that monitors the actual position of work piece 12; and 2) a counter 30 that monitors all channels of measurement, the “begin cut” and “end cut” signals, and determines if the channels of measurement agree taking into consideration the plus and minus tolerance as well as the kerf, and lateral and/or vertical displacement of work piece 12.

The cut-to-length system 10 includes doing something that no cut-to-length system manufacturer is known to have done, namely adding “multiple channels of measurement” to the cut-to-length system 10 that will block the saw blade 14 from cutting if the channels do not agree. The cut-to-length system 10 also includes sensor 28 that is “crush proof” and can be fitted in a variety of locations on existing cut-to-length systems, including fitting between fixed vise 22 that accommodates ease of use for the operator. Sensor 28 is designed not only to measure lateral movement, but also vertical movement. Counter 30 of cut-to-length system 10 is also unique in that it takes into account the plus/minus tolerance of desired cut length 16 as well as the kerf and other considerations. In addition to hardware and electromechanical systems of the invention, cut-to-length system 10 also consists of software that provides value-added features that improve operator efficacy and accuracy when setting up cut-to-length system 10; which will reduce and potentially eliminate wasted material due to “out-of-specification/out-of-tolerance” cuts. Finally, cut-to-length system 10 integrates a point of sale system where the “job” is first documented and specified with cut-to-length system 10 where the finished part 26 is actually cut. It is important to note that when a “job” is specified in a point of sale system and made available to a cut-to-length system 10, this further reduces data entry errors when the operator is setting up cut-to-length system 10 for the “job”.

In another embodiment of the present invention, cut-to-length system 10 consists of “logging” all data captured from cut-to-length system 10, the operator, and the process of verifying the length of finished parts 26 for future analytics and the benefits derived from this data.

As stated above, cut-to-length system 10 includes a sensor 28 that monitors and tracks the current position of work piece 12.

Sensor 28 consists of a design intended to meet or exceed the rugged standards required by the operating environments of many cut-to-length systems as well as very strict precision requirements as necessitated by the exactness in measuring tolerances within two thousandths of an inch or less. Sensor 28 monitors and tracks the horizontal movement along the length of work piece 12, as well as monitoring and tracking the vertical movement of work piece 12.

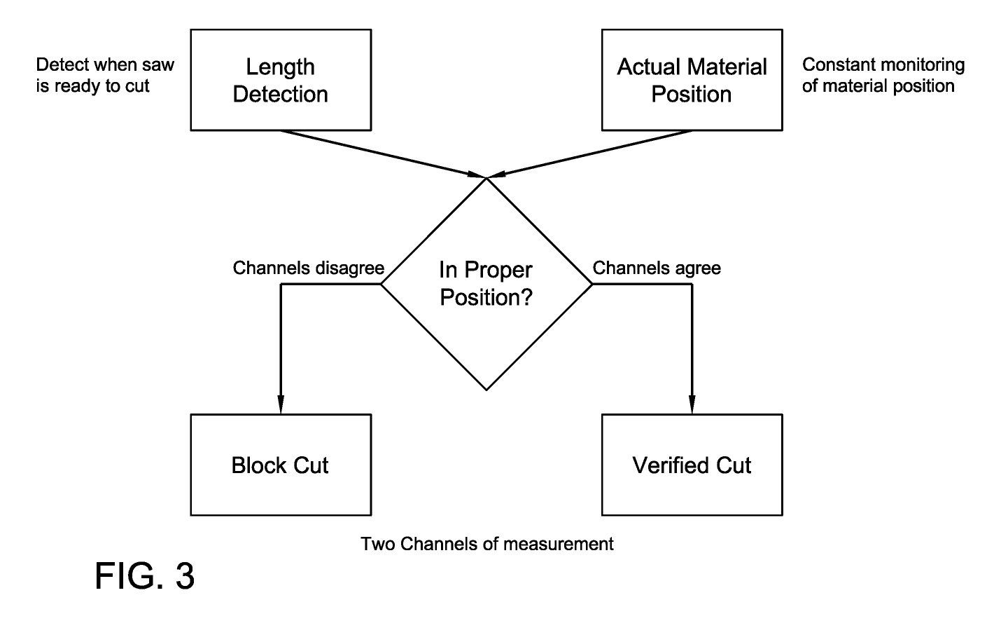

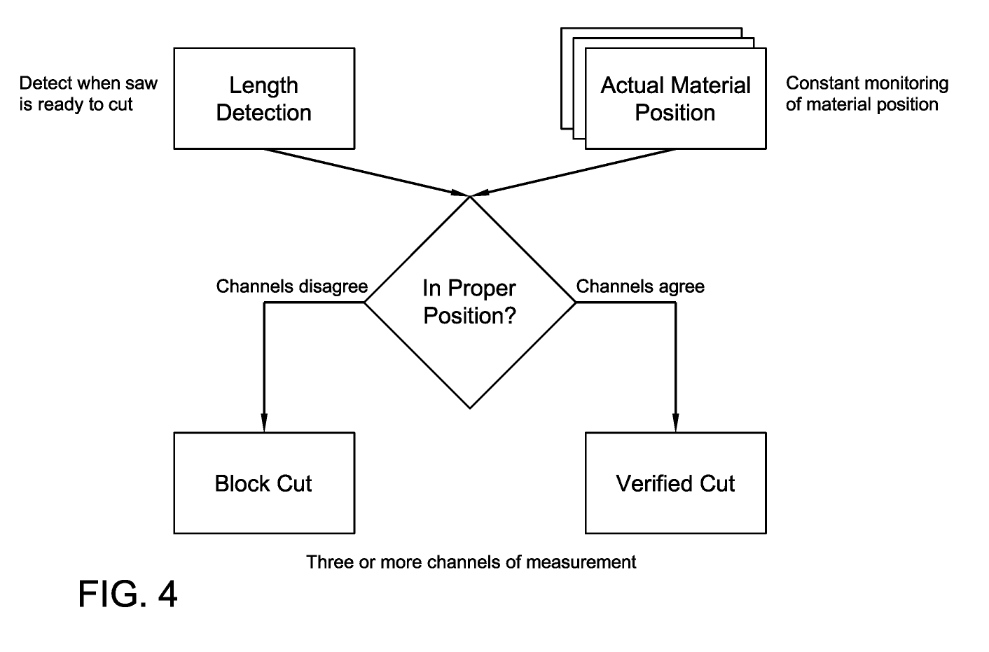

Cut-to-length system 10 further comprises counter 30 that monitors and tracks all channels of measurement (two or more) and ensures that at least two channels agree before enabling saw blade 14 to cut work piece 12. As further apparent from FIGS. 3 and 4, the method of using cut-to-length system 10 consists of a process that “blocks” saw blade 14 from cutting if two or more channels of measurement do not agree that work piece 12 is within tolerance, thus eliminating a cut that results in a part that is out of tolerance. Counter 30 consists of inputs for monitoring and tracking the functioning of cut-to-length system 10 including the “begin cut” and “end cut” signals, the desired cut length tolerances, and inputs for the saw blade kerf.

Cut-to-length system 10 further comprises a panel (not shown) that contains a keypad and a read out screen that enable data entry and access to the internal features of cut-to-length system 10. The panel also contains an override button that allows the operator to override a blocked cut.

In one embodiment of the present invention, cut-to-length system 10 is integrated with a point of sale system where the “job” is first documented and described in terms of desired cut length, plus or minus tolerance and number of parts, while also providing real-time “notifications” that work piece 12 is not within tolerance and therefore saw blade 14 should be blocked. The invention also contemplates a web-portal that enables the operator(s) to see the status of any cut-to-length system 10 in production from a computer, tablet or smart phone.

In operation, the operator sets up cut-to-length system 10 for a job by loading work piece(s) 12 onto a saw conveyor system 32 and “zeroing” the leading edge of work piece(s) 12 to saw blade 14. This process varies by system, but regardless, the process results in a clean leading edge that is zero distance from saw blade 14. At this point, the operator places sensor 28 onto work piece(s) 12. The objective is to make sensor 28 easy for the operator to use and work with throughout the cut-to-length system 10 setup, cutting and tear-down processes.

The operator then selects the job or otherwise enters the job specification using the panel, which contains a data entry keypad and a read-out screen. The operator may also choose to enter an e-mail address or phone number to be notified when cut-to-length system 10 is not within tolerance and blocked from cutting work piece 12.

Once the specification is entered, either by the operator or by the point of sale integration software or system, the operator then starts cut-to-length system 10 and enables the automatic mode to cut multiple finished parts 26 of the same length.

Sensor 28 reads the position of work piece 12 as cut-to-length system 10 indexes work piece 12 for the first finished part 26. Cut-to-length system 10 indexes work piece 12 to the position as entered by the operator and then initiates the head down. Counter 30 detects the head down signal. The head down signal is cut-to-length system 10 way of indicating that a finished part 26 will be at length and represents the primary channel of measurement. Basically, saw blade 14 has said, “I'm cutting work piece 12 now.” Therefore, work piece 12 must be the correct length.

The “begin cut” signal is important because work piece 12 may continue to move after primary mover 24 has stopped moving and/or limit switch 18 has indicated an end position. Cut-to-length system 10 waits until saw blade 14 is actually ready to begin cutting work piece 12. Only then does cut-to-length system 10 validate the position of work piece 12 as described herein.

Counter 30 detects the “begin cut” signal and logs the fact that the primary channel of measurement has completed. Counter 30 then reads the actual position of work piece 12 from sensor 28, the second channel of measurement. Counter 30 then determines if sensor 28 agrees with the primary channel of measurement. If multiple secondary channels of measurement are present, counter 30 will apply the heuristics as configured by the operator. For example, the majority of channels must agree before the cut is enabled. These heuristics can be configured at runtime and any number of secondary channels of measurement can be added.

When counter 30 determines that the channels agree that work piece 12 length is within tolerance, saw blade 1142 is allowed to continue. Counter 30 then logs the cut information and stores it for future use.

When counter 30 determines the channels do not agree, saw blade 12 is not allowed to continue. The cut is blocked. Counter 30 sends a “blocked” signal that is used by cut-to-length system 10 to notify the operator(s). The operator can be notified via an electromechanical system on cut-to-length system 10 itself, e.g., a bright flashing light, and/or the operator can be notified remotely, e.g., by a text message and/or e-mail.

In the case where cut-to-length system 10 blocks saw blade 14, the operator can repair the problem. Counter 30 will automatically detect when work piece 12 is in tolerance and will enable saw blade 14 to continue. Counter 30 will then log the good cut and all of the information including the fact that the operator had to adjust/fix the position of work piece 12 to get finished part 26 in to tolerance.

The operator is also given the ability to override a blocked cut by pressing a button on the panel that allows saw blade 14 to continue in spite of being out of tolerance. In this case, counter 30 then logs the cut information, including the fact that the operator allowed the out-of-tolerance cut.

When cut-to-length system 10 detects the cut is complete, for example, when saw blade 14 hits a bottom limit switch, saw blade 14 begins the process to return saw blade 14 back to the start position. Counter 30 detects this “end cut” signal and resets the index position to zero. This enables counter 30 to monitor the remaining work piece(s) 12 to be indexed for subsequent finished parts 26.

This “end cut” signal is important because the remaining work piece(s) 12 can slip when saw blade 14 is returning back to the top. Saw blade 14 must pass back up past the work piece 12. Saw blade 14 rubs against work piece 12, which is still held in position by fixed vise 22. In the process of passing past work piece 12, saw blade 14 can knock work piece 12 and move it out of position either up vertically or back laterally. In either case, work piece 12 is now out of position.

In order for cut-to-length system 10 to set up for the next finished part 26, cut-to-length system 10 requires fixed vise 22 and index vise 20 to swap “hold” on work piece 12 so that index vise 20 can move back to the start position to grab the next finished part's 26 worth of work piece 12 to be fed into saw blade 14. This process is called “indexing,” and is a particular concern because work piece 12 is subject to slippage. For example, while index vise 20 is moving back to the reset position, index vise 20 may catch a burr on work piece 12 and incidentally cause work piece 12 to move slightly.

Cut-to-length system 10 does not account for the vertical and/or lateral displacement of work piece 12 when “indexing” work piece 12, which may result in a finished part 26 that is out of tolerance.

Counter 30 monitors and tracks the position of work piece 12 during the entire indexing and cutting processes. When saw blade 14 begins the cut, counter 30 detects the “begin cut” signal. Counter 30 then detects if work piece 12 is finally rested and in place for the cut cycle. Once work piece 12 is finally rested and in place for the cut cycle, cut-to-length system 10 then “verifies” the cut as described herein.

Should saw blade 14 advance a cut that cut-to-length system 10 fails to detect, for example, counter 30 did not receive the “begin cut” signal, but did receive the “end cut” signal, or vice versa, cut-to-length system 10 will detect an “unverified cut” and will block saw blade 14 from making any more cuts. Counter 30 blocks saw blade 14 from cutting, logs the cut information, and notifies the operator. This alerts the operator to a potential problem with cut-to-length system 10 and minimizes the number of potential bad finished parts 26, as they are not being verified as designed/intended.

The present invention affords a number of convenience features and benefits. Cut-to-length system 10 can be configured having a run time that limits saw blade 14 from cutting more than a set number of out-of-tolerance parts per a particular batch count before saw blade 14 is “blocked” from cutting. This is useful in situations where some waste is expected and tolerated. For example, letting cut-to-length system 10 run overnight with limited human supervision where one bad finished part 26 might be worth 100 good ones.

The integration of cut-to-length system 10 with point of sale data may enable business decisions to be based on past performance data and capabilities. For example, cut-to-length system 10 can provide reports on the efficacy of cut-to-length system 10 in a company's use providing visibility into production status and capabilities, thus enabling the company to better quote a job's price and turnaround time.

The present invention affords considerable advantages for cut-to-length system 10 owner or company, including higher reliability of cut-to-length system 10, higher efficiency and accuracy setting up cut-to-length system 10, reduced production downtime, higher repeatability, and reduced waste material giving cut-to-length system 10 owner or company a competitive advantage over competitors using a single channel measurement systems.

In light of the foregoing, it should be appreciated that the present invention significantly advances the art by providing a method and apparatus for verifying length of work pieces that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from claims that will follow in a non-provisional utility application.

What is claimed is:

1. An apparatus for ensuring the accuracy and utility of cut-to-length systems, comprising:
a primary channel of measurement producing a first measurement of a work piece taken between a cutting mechanism and a limit stopper; and
a second channel of measurement producing a second measurement, wherein cutting of the work piece by the cutting mechanism cannot be made unless the first measurement agrees with the second measurement.

2. The apparatus of claim 1 wherein if the first measurement does not agree with the second measurement, then the cutting mechanism will be blocked from cutting the work piece.

3. The apparatus of claim 1 wherein the second channel of measurement comprises a sensor and a counter.

4. The apparatus of claim 3 wherein the sensor monitors both a vertical position and a horizontal position of the work piece and the counter determines if the first measurement and the second measurement agree.

5. The apparatus of claim 4 wherein the counter takes into account a plus/minus tolerance of the first measurement when determining if the first measurement and the second measurement agree.

6. The apparatus of claim 1 wherein the apparatus further comprises a primary mover system comprising a fixed vise to hold onto the work piece, and an index vise to move the work piece towards the cutting mechanism.

7. A method for ensuring the accuracy and utility of a cut-to-length system, comprising:
indexing a work piece with respect to a cutting mechanism to create a first measurement;
monitoring a position of the work piece with respect to the cutting mechanism to create a second measurement;
comparing said first measurement and said second measurement; and
allowing the cutting mechanism to cut the work piece only when the comparison of the first measurement and the second measurement agree.

8. The method of claim 7 wherein the first measurement is created by abutting the work piece against the cutting mechanism and then locking a limit stopper into place against the work piece so that the distance between the cutting mechanism and the limit stopper is equal to a desired cut length.

9. The method of claim 7 wherein the monitoring of the work piece is done by a sensor that monitors both a vertical position and a horizontal position of the work piece.

10. The method of claim 7 wherein the comparison of the first measurement and the second measurement is done by a counter wherein the counter takes into account a plus/minus tolerance of the first measurement when determining if the first measurement and the second measurement agree.

11. The method of claim 7 wherein if the comparison step determines that the first measurement and second measurement does not agree, then the cutting mechanism will not be allowed to cut the work piece.
